(19) United States
(12) Patent Application Publication
(10) Pub. No.: US 2003/0209209 A1
(43) Pub. Date: Nov. 13, 2003

(54) Automated animal self-grooming device

(76) Inventors: Steven D. Udelle, Punta Gorda, FL (US); Laura L. Udelle, Punta Gorda, FL (US)

Correspondence Address: Steven D. Udelle, 13 Seasons Drive, Punta Gorda, FL, 33983-5432, US

(21) Appl. No.: 10/143,626

(22) Filed: May 10, 2002

(51) Int. Cl. A01K 13/00

(52) U.S. Cl. 119/609

(57) ABSTRACT

A wall mounted animal self-grooming device that rotates a cylindrical rubbing means having bristles on its exterior surface about its axis by utilizing a small electric motor. The electric motor is mounted within a housing and coupled to the rubbing means through an opening in the housing base. A transformer and plug assembly is removably stored within the housing and is electrically connected to the electric motor by a length of electrical cord, the unused portion of which is also coiled and stored in the housing. The transformer and plug assembly have at least two prongs that extend from a surface thereof for insertion into a standard electrical wall outlet. In one embodiment, the housing is removably attached to a house wall over the electrical wall outlet having the transformer and plug assembly plugged therein. The transformer and plug assembly protrudes into the housing through a hole in the back wall of the housing. The rubbing means is directly coupled to the electric motor and extends outward from the housing in an orientation that is parallel to the wall on which the device is mounted, thus keeping required space to a minimum and providing a compact configuration. A pair of flanges with slots therein are provided on each side of the housing back wall to provide the means for removably fastening the housing to a house wall. In a second embodiment, the length of electrical cord enables the device to be mounted on a wall at a location spaced from the electrical outlet into which the transformer and plug assembly is plugged.

### FIELD OF THE INVENTION

The present invention relates to animal self-grooming devices and, more particularly, to a light-weight, portable, automated animal self-grooming device readily mountable on and removable from a vertical wall, such as, for example, an interior house wall, and the device uses standard electrical house wall outlets.

### BACKGROUND OF THE INVENTION

It is estimated that there are more than 60 million domesticated cats in the United States at the present time, and the popularity of cats continue to grow. One problem that pet owners contend with is that of animal hair and in particular with cat hair because cats instinctively rub the sides of their bodies on things in their environment, such as, furniture, draperies, and people's legs. Another problem to be contended with by cat owners is the cat's need to scratch with its claws or nails. To reduce the problem of animal hair throughout the cat owner's home and to prevent damage to household furniture, there are many generally stationary self-grooming devices available upon which the cat may rub itself and deposit hair thereon. The stationary devices require the cat to provide all of the motions or efforts to satisfy their need for grooming and hair removal, and thus is not attractive enough to prevent the cat from grooming itself on other objects in the home. It is also well known to provide something for the cat to claw, and carpet like material is provided on posts especially for the cat or combined with the stationary self-grooming devices, such as, on platforms containing vertical brushes which are mounted thereon. Mechanically assisted animal self-grooming devices are also known which simulate hand brushing which cats appreciate more than stationary self-grooming devices, and thus tend to use them longer and more often. The existing mechanically assisted animal self-grooming devices for indoor house use are generally floor models having platforms from which rotatable brushes vertically extend and are driven by an electric motor having a cord which resides on the floor between the device and the electrical wall outlet. Such devices take up floor space in the home and the cords can be tripped over, if in the pet owner's walking areas.

One mechanically assisted animal self-grooming device is disclosed in U.S. Pat. No. 2,721,538 to R. E. Latham. In this animal operated power brush grooming device, two vertically disposed rotatable brushes are spaced apart from each other and a third horizontally disposed rotatable brush is located at the upper ends of the two vertical brushes. An electric motor rotates all three brushes concurrently by a gear arrangement, when energized by a depression switch located beneath a spring biased platform which closes the switch to operate the electric motor whenever the platform is depressed by, for example, a dog.

U.S. Pat. No. 3,175,537 to M. A. Paul discloses an apparatus for brushing a large animal with rotatable cylindrically shaped horizontally and vertically disposed brushes. An insecticide is concurrently applied to the animal when brushed by applying the insecticide to the brushes that contact the animal. The brushes are rotatably mounted in an inverted L-shaped frame adapted for vertical movement relative to the ground. The vertical brush engages the side of the animal and the horizontal brush engages the top area of the animal. An electric motor is operatively connected to both brushes for concurrent rotation thereby. The motor is operated in response to vertical movement of the L-shaped frame or to the sensing of the presence of an animal by an electric eye. Bumper bars adjacent the brushes limit the amount of pressure an animal may apply against the brushes.

U.S. Pat. No. 5,628,282 to S. D. Udelle discloses a mechanically assisted animal self-grooming device which simulates the brushing movements of a human hand by using a rotatable rubbing means having bristles thereon. The rubbing means is rotated at a predetermined speed by a miniature electric motor. The device has a stationary circular base with a generally flat upper surface, and the rubbing means is vertically disposed above and directly coupled to the electric motor, which is centrally mounted on the upper surface of the base for rotating the rubbing means about its axis. The electric motor may be automatically actuated by an animal sensor or by manual operation of a reversible switch to rotate the rubbing means in either direction.

For examples of stationary animal self-grooming devices, refer to U.S. Pat. No. 2,865,329 to G. Elliott; U.S. Pat. No. 5,176,105 to M. P. Madden; U.S. Pat. No. 4,907,540 to E. B. Reynolds; U.S. Pat. No. 5,842,440 to R. E. Bell, Jr.; U.S. Pat. No. 4,996,946 to J. C. Olson; and U.S. Pat. No. 4,926,796 to A. B. Leopold. Elliott discloses a recreation and grooming device for animals having a brush of generally rigid U-shaped configuration with the bristles extending inwardly and a pair of ground engaging stakes which are spaced apart and parallel to each other. A pair of clamps releasably grip the stakes and the brush. The clamps provide the means for supporting the brush in a vertical plane and in an adjustable relationship with the ground. The loose ends of the U-shaped brush are held together with a rubber band to provide a closed elongated opening only large enough to permit the owner's pet to pass therethrough and be groomed by the bristles. Madden discloses a fur grooming apparatus having a base and a twisted wire retaining bristles radially extending 360 degrees from around the wire and along its length. The twisted wire with bristles is formed into a U-shaped configuration with its opposing ends extending through holes in the base and fastened thereto. Carpet material covers the surface of the base for clawing and a center hole in the base can be used to pour a cat attracting material therein, such as catnip. Reynolds discloses a two piece wall mounting bracket which are hinged together and two planar surfaces which are hinged together. Each of the two hinged pieces of the bracket has a clip and a projecting fastener, and each of the planar surfaces have holes for mounting on the bracket clips and fasteners. The outer surfaces of the planar surfaces contain a plurality of bristles to catch and hold a cat's loose fur. Receptacles are attached to the bottom edge of the planar surfaces by hinges connected to the bottom of the receptacles. Clips formed on the outer planar surfaces latch over the open top edge of the receptacles to hold them in place. Catnip is stored in the receptacles to attract cats and give them incentive to scratch themselves on the bristles. Bell, Jr. discloses a self-grooming aid for cats that has a cylindrical pan-like supporting base with a cylindrical holder located at its center which has an axial opening therethrough and a rim around the periphery of the base. A cylindrical corrugated mat with a centrally located hole is placed in the pan-like base and is held therein by the base rim when scratched by a cat. A cylindrical brush has bristles at one end portion and a bristle free portion at the other end for either manual brushing or insertion into the cylindrical holder in the base. Olson discloses a portable rubbing article for a cat having a flat base with a removably attached pedestal that extends upwardly from the base. The base is covered with a material such as a carpet. The lower portion of the pedestal contains a ribbed rubber member that is concave at the center, and the upper portion of the pedestal is covered with a material such as carpet. The owner's cat may claw the carpet and groom itself on the ribbed portion. Leopold discloses two toothed plates that may be hinged or bent relative to each other. The teeth extend from a surface of each plate, and the teeth are preferably conical in shape and uniformly distributed thereon. An aperture plate has a pattern of holes that match the pattern of teeth and are mounted on the toothed plates. Removal of the aperture plates cleans the toothed plates and removes cat hair deposited thereon when the cat scratches itself on the teeth exposed through the aperture plate.

### SUMMARY OF THE INVENTION

In one aspect of the invention, there is provided an automated animal self-grooming device, comprising: a housing having a base with an opening therein and a back wall vertically extending from one edge of the base, a shaft having a substantial portion extending through the base opening, the shaft being generally perpendicular to the base; means for rotating the shaft being mounted within the housing; an electrical plug means stored in the housing and having at least two prongs extending therefrom for connecting to an electrical power source, the electrical plug means being connected to the means for rotating the shaft by a predetermined length of electrical wire that is coiled and removably stored in said housing, the electrical plug means being removable from the housing through the hole in the housing back wall prior to connecting said electrical plug means to the electrical power source; and a symmetrical rubbing means having an axis and being directly coupled to the shaft portion extending from the base, so that the rubbing means is disposed from and substantially perpendicular to the base, and when the means of rotating the shaft is operated, the rubbing means is rotated about its axis.

In one embodiment of the invention, the animal self-grooming device is attached to a house wall after it is connected to an electrical power source by first removing the electrical plug means from the housing through the hole in the housing back wall and inserting the prongs of the electrical plug means into a standard electrical wall outlet of a house. After the electrical plug means is plugged into the wall outlet, the animal self-grooming device may be attached to the wall by using fasteners through the back wall flanges. The device may be spaced from or installed over the wall outlet with the electrical plug means plugged therein. In this later arrangement, the housing back wall hole surrounds, but does not contact the electrical plug means. In this embodiment, the device may be attached to the house with the rubbing means being selectively oriented either in the upward or downward direction relative to the housing base or house floor.

In another embodiment of the invention, the pair of flanges on the housing of the animal self-grooming device extends from opposite sides of the housing back wall. The flanges are coplanar with the surface of the housing back wall and have elongated slots therein. A typical fastening means, such as screws, for example, may be used through the flange slots to fasten the flanges to the wall. The device may be attached to the house wall straddling over the wall outlet with the electrical plug means plugged therein or a location spaced from the wall outlet. When the device is attached over the wall outlet with the electrical plug means inserted therein, the electrical plug means protrudes through the hole in the housing back wall with the housing flanges being located on each side of the electrical outlet. The predetermined length of wire interconnecting the electrical plug means and the means for rotating the shaft coupled to the rubbing means enables the device to be mounted on a wall around the corner from an electrical wall outlet. Once the device is attached to the wall, an animal may groom itself against the rubbing means whether the rubbing means is rotating or not.

It is therefore an object and advantage of the present invention to provide to a pet a preferred, out of the way place to rub their bodies; simulating the grooming action of the human hand; thereby keeping dirt, body oil and loose hair on the brush and off other surfaces in the home such as furniture, wall edges, and the pet owner's legs.

Another object of the invention is that the device can be made in any size, utilizing the same components, yet remain structurally stable and useful to any size pet, even larger dogs, due to the array of mounting possibilities; such as upside down and at any height, the major portion of the pressure applied by an animal against the rubbing medium would be set to be closest to the motor shaft as opposed to the opposite end of the rubbing medium, thereby allowing larger animals the satisfaction of a good brushing without the motor shaft getting strained due to leverage.

Another advantage of the invention is that it has a removable rubbing means for easy cleaning, replacing or interchanging with various other rubbing mediums of different sizes, shapes or textures.

Another advantage of the invention is that it is affordable, attractive, compact, and suitable for most any area around the home, and can even be utilized by a pet in the off position.

### BRIEF DESCRIPTION OF THE DRAWINGS

The present invention will now be described, by way of example, with reference to the accompanying drawings, in which like reference numerals refer to like elements, and in which:

FIG. 1 is an isometric view of an animal self-grooming device in accordance with the present invention and shown plugged into an electrical wall outlet of a house with its rubbing means oriented in the downward direction;

FIG. 2 is an isometric view similar to FIG. 1, but showing the rubbing means oriented in the upward direction;

FIG. 3 is an elevation view of an alternate embodiment of the rubbing means shown in FIG. 1;

FIG. 4 is an isometric view of the rubbing means shown in FIG. 3 and showing the top thereof which has an alternate means for attachment;

FIG. 5 is a view similar to FIG. 1, but showing an alternate embodiment of the present invention;

FIG. 6 is a view similar to FIG. 5 showing an optional additional wall protector and scratching pad; and

FIG. 7 is an isometric view of another embodiment of the animal self-grooming device of the present invention.

### DESCRIPTION OF THE PREFERRED EMBODIMENT

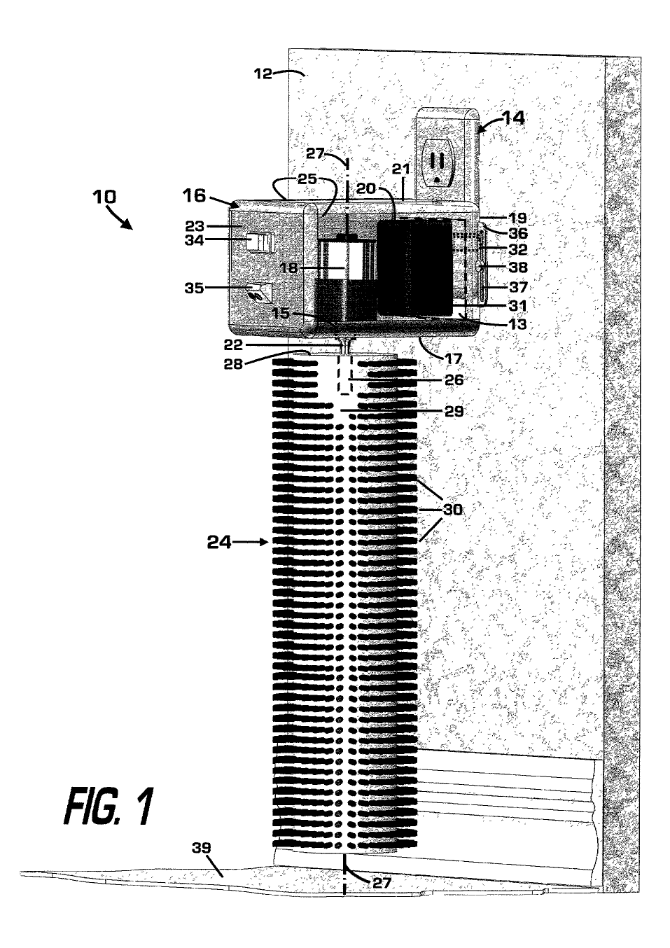

In FIG. 1, an isometric view of the animal self-grooming device 10 of the present invention is shown mounted on a house wall 12, partially shown, and electrically engaged with a standard electrical wall outlet 14 of a typical house. The animal self-grooming device, as shown, is ready for use by an animal, such as a domestic cat, to groom itself.

The device 10 comprises a housing 16 that contains therein a small electric motor 18, a removable electrical plug means 20, such as, for example, a combined transformer and plug assembly, and a predetermined length of wiring (not shown) that electrically connects the transformer and plug assembly to the electric motor. Any suitable electrical plug means will suffice which will reduce standard 115 volt AC house current to that required for small electric motors. The housing 16 is generally rectangular in shape and is constructed of a suitable material. The housing has a base 17, a back wall 19, top wall 21, front wall 23, and opposing side walls 25, with one side wall being transparent to show the interior of the housing. The back wall extends vertically from one edge of the base and the front wall extends from an opposing edge of the base and is parallel to the back wall. The top wall is connected to the front and back walls and is parallel to the base. Optionally, the top wall may be removable to permit access to the interior of the housing. The two side walls are parallel to each other and connect to opposing edges of the base, front, back, and top walls to complete the housing.

The electric motor is attached to the base by any well known means, such as by screws (not shown) and has a shaft 22 that extends perpendicularly through a circular opening 15 (shown in dashed line) in the base. A symmetrical rubbing means 24 has an axis 27 and is axially coupled at one end 28 to the motor shaft 22. A manually actuated three position switch 34 mounted on the front wall 23 is connected to the transformer and plug assembly and the electric motor by wiring (not shown) to direct the low voltage power to the electric motor. The position of the switch determining whether the electric motor is off or rotates the rubbing means in the clockwise or counterclockwise direction.

Optionally, a conventional animal sensing sensor 35 could be provided on the front wall that would either replace the three position switch or be an addition to the three position switch. The wiring of such a typical sensor is well known and therefore not shown. The externally mounted animal sensor causes the electric motor to operate at a preselected rate of revolution when the presence of an animal is sensed by the sensor. In another option, an electronic means (not shown) is provided in the housing. The electronic means is programmed to automatically change the direction of rotation of the electric motor for rotating the shaft at preselected intervals of time.

In the preferred embodiment, the electric motor shaft 22 extends through the base opening 15 for rotation therein and is directly coupled to rubbing means 24. The coupling may be by any suitable means, such as, for example, a flat portion (not shown) on the shaft 22 being inserted in a complementary shaped recess 26 (shown in dashed line) axially formed in one end 28 of the rubbing means 24. The electric motor shaft portion in the recess of the rubbing means may be removably fixed thereto by any well known means, such as, for example, a set screw (not shown). With the rubbing means 24 being coaxially coupled to the electric motor shaft, the rubbing means is generally perpendicular to the housing base 17.

In the embodiment of FIG. 1, the rubbing means 24 is a brush that has a solid cylindrical body 29 with bristles 30 on its outer surface. When the device 10 is mounted on the house wall 12, the rubbing means or brush 24 is parallel to the wall with the axis 27 of the rubbing means spaced a sufficient distance from the wall to prevent the bristles 30 from contacting the wall.

The device 10 is removably mounted on a house wall 12 and the electrical plug means 20 is plugged into an electrical wall outlet 14. When the rubbing means is directed towards the floor 39 of the house, as shown in FIG. 1, the rubbing means does not contact the floor. Thus, the length of the rubbing means determines the location of the device 10 above the floor 39.

The electrical plug means or transformer and plug assembly 20 has at least two prongs 32 (shown in dashed line) that extend perpendicularly from surface 31 thereof. The transformer and plug assembly is electrically connected to the electric motor 18 via the three position switch 34 and/or sensor 35 by standard wiring procedures well known in the industry and therefore not shown here. The back wall opening 13 has a size and shape that is larger than the outer surface of the electrical plug means or transformer and plug assembly 20. To install the device 10, the transformer and plug assembly 20 is first removed from the housing 16, where it is stored, through an opening 13 in the housing back wall 19 and the prongs 32 inserted into an electrical wall outlet 14. Next, the housing 16 of the device 10 is attached to the vertical wall 12 as the transformer and plug assembly 20 remain hidden in the housing 16, as discussed later.

In one embodiment of the invention, the device 10 is attached to the wall over the electrical wall outlet 14 with the transformer and plug assembly 20 plugged in to the electrical wall outlet 14. The back wall opening 13 of the housing 16 has a size and shape that surrounds but does not contact the outer surface of the transformer and plug assembly even though the transformer and plug assembly protrudes into the housing through the back wall hole 13.

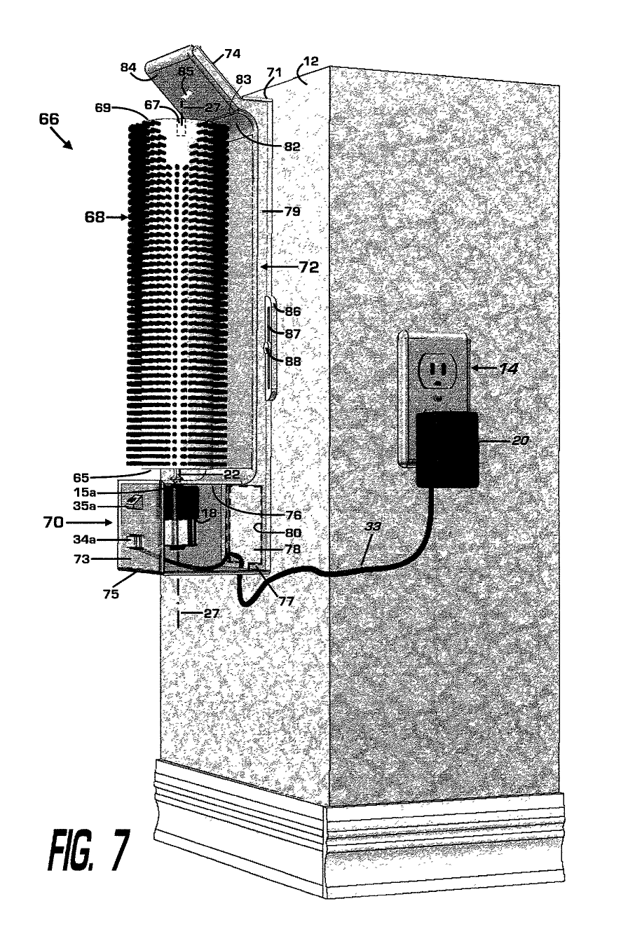

The predetermined length of electrical cord 33 (see FIG. 7), which is normally coiled and stored in the housing, is used to connect the electric motor to transformer and plug assembly. This would enable the transformer and plug assembly to be removed from the animal self-grooming device and the device mounted on a wall at a location remote from an electrical wall outlet. The base edge adjacent the back wall of housing 16 has a slot (not shown) therein for the cord 33 to pass through when the transformer and plug assembly is plugged into an electrical wall outlet and the device 10 is mounted remote from the electrical outlet.

The device is attached to the wall by a pair of flanges 36, one provided on each side of the back wall of the device for rigid support. The flanges 36 extend from the opposing edges of the back wall 19 that are attached to the side walls 25. The flanges are substantially coplanar with the back wall, so that each flange lies flat against the wall 12, and when the device is mounted over an electrical wall outlet 14, a flange is positioned on each side of the electric wall outlet. Elongated slots 37 in the flanges permit a fastening means, such as, for example, screws 38 to be inserted through the slots and into the wall to provide rigid structural support for the device when an animal grooms itself against the rubbing means.

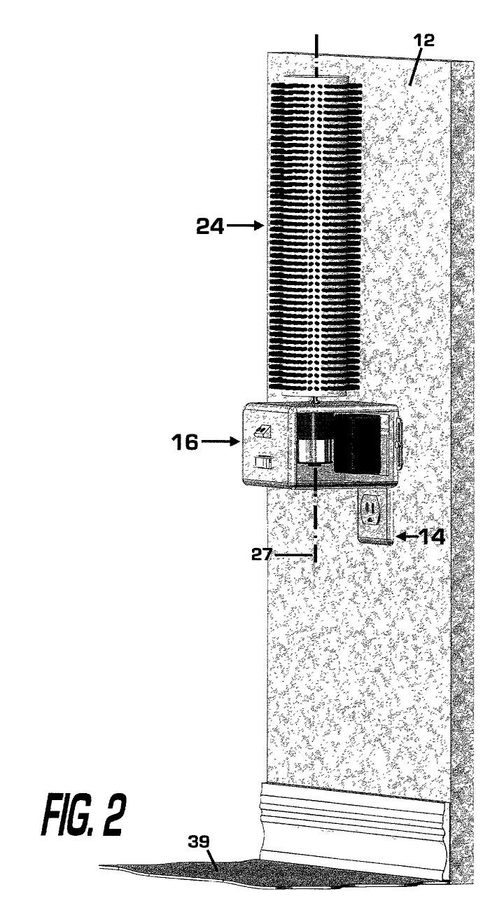

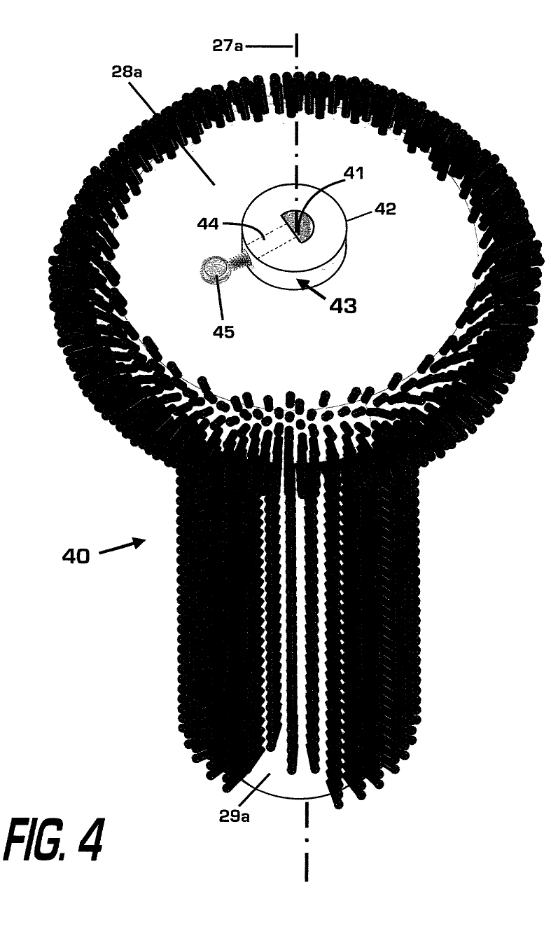

Referring to FIG. 2, the animal self-grooming device of FIG. 1 is shown plugged into the electrical wall outlet with the rubbing means extending upward from the floor 39. This places the rubbing means higher from the house floor for larger animals to use. Another means for coupling the electric motor shaft 22 to the rubbing means or brush 24 is similar to that shown in FIG. 4 of an alternate embodiment of rubbing means 40. For this alternate means of coupling (not separately shown for rubbing means 24), refer to FIG. 4, where the end 28a of the cylindrical rubbing means 40 has a cylindrical projection 42 extending coaxially therefrom which has a diameter smaller than that of the rubbing means. The cylindrical projection has an axially formed cylindrical recess 41 therein to form a collar 43. The electric motor shaft 22 is inserted into the collar recess 41. A threaded hole 44 (shown in dashed line) is provided in the collar that is perpendicular to the axis 27a of the collar and has a set screw 45 installed into the threaded hole to lock the electric motor shaft 22 to the rubbing means.

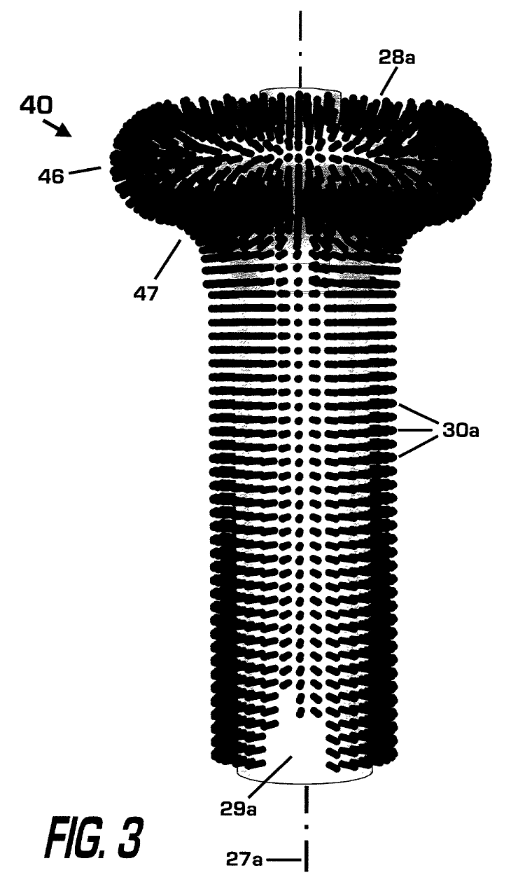

An alternate embodiment of the rubbing means 24 is shown in FIG. 3. In this embodiment, the rubbing means 40 is a cylindrical brush with an axis 27a having a rigid body 29a with bristles 30a extending from its outer surface. A circular flange-like extension 46 is integrally and coaxially formed on the end 28a of the brush that is coupled to the electric motor shaft 22. The flange-like extension 46 has a larger diameter than the remainder of the cylindrical brush, and gives the rubbing means a mushroom-like appearance. The outer periphery of the flange-like extension has a convex shape, and the brush 40 has a concave shape in the transitional interface area 47, where the flange-like extension meets the cylindrical rigid body of the brush. The configuration of the brush 40 permits simultaneous grooming of the top as well as the sides of an animal's coat.

In FIG. 4, an isometric view is depicted showing the top end 28a of the rubbing means 40. As described earlier with respect to an alternate embodiment of rubbing means 24, the end 28a of the cylindrical rubbing means 40 has a flange-like extension 46. A cylindrical projection 42 extends coaxially from the flange-like extension 46 that has a diameter smaller than that of the cylindrical rigid body 29a of the rubbing means or brush 40. The cylindrical projection 42 has an axially formed cylindrical recess 41 therein to form a collar 43. The electric motor shaft 22 is installed in the recess 41 of the collar. A threaded hole 44 (shown in dashed line) is provided in the collar that is perpendicular to the axis 27a of the collar. A set screw 45 is installed into the threaded hole to lock the electric motor shaft 22 to the rubbing means 40.

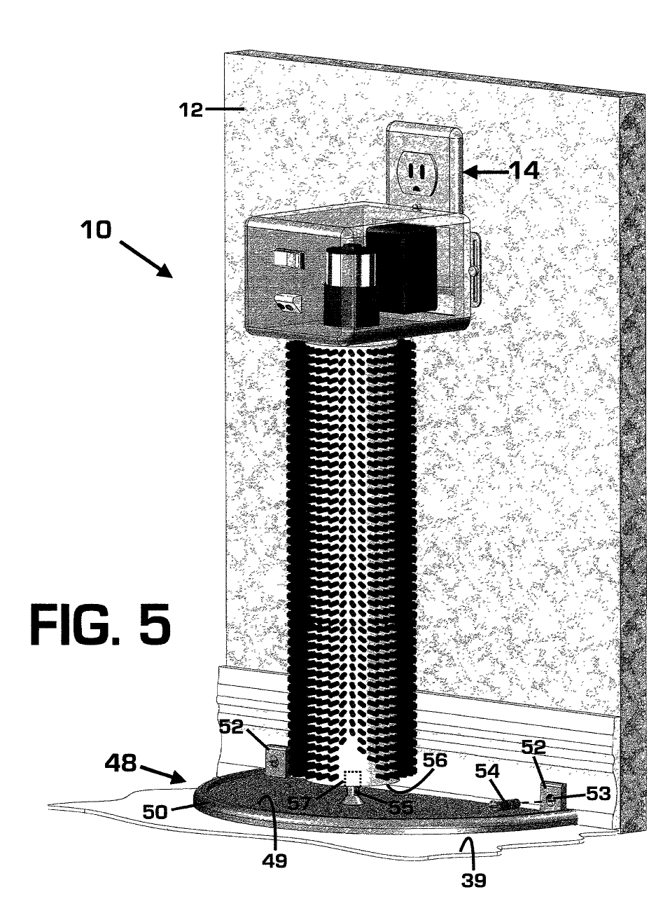

In FIG. 5, the animal self-grooming device 10 is shown with an optional hair and debris collecting pad 48 which also serves as a clawing or scratching medium. The pad 48 is shown as a flat semi-circular plate, but could be any shape. The pad has an upper surface that contains a material 49 suitable for both animal clawing or scratching and collecting animal hair and other debris that may fall from the rubbing means, such as, for example, a piece of ordinary carpet. The pad has a rim 50 around the periphery thereof that extends upwardly from its upper surface to hold the material in place. For additional holding power, a piece of double sided carpet tape may be used to hold the material 49 on the pad. The back of the pad 48 adjacent the house wall 12 has a pair of ears 52 extending upwardly from the upper surface of the pad. Each pad ear 52 has an aperture 53 therein for the use of a fastening means 54, such as, for example, screws to fasten the pad to the house wall 12.

Optionally, the rubbing means 24 has a short cylindrical recess 57 (shown in dashed lines) coaxially located on the end 56 of the rubbing means and is mated to short rigid shaft 55 extending upwardly from pad 48. When the rubbing means is rotated by the electric motor, the short shaft 55 is aligned within the cylindrical recess 57 of the rubbing means, so that the end 56 of the rubbing means 24 is further stabilized when the animal grooms itself against the bristles of the rotating rubbing means. A small sleeve bearing (not shown) may be employed between the surfaces of the short shaft 55 and recess 57 to alleviate unwanted friction.

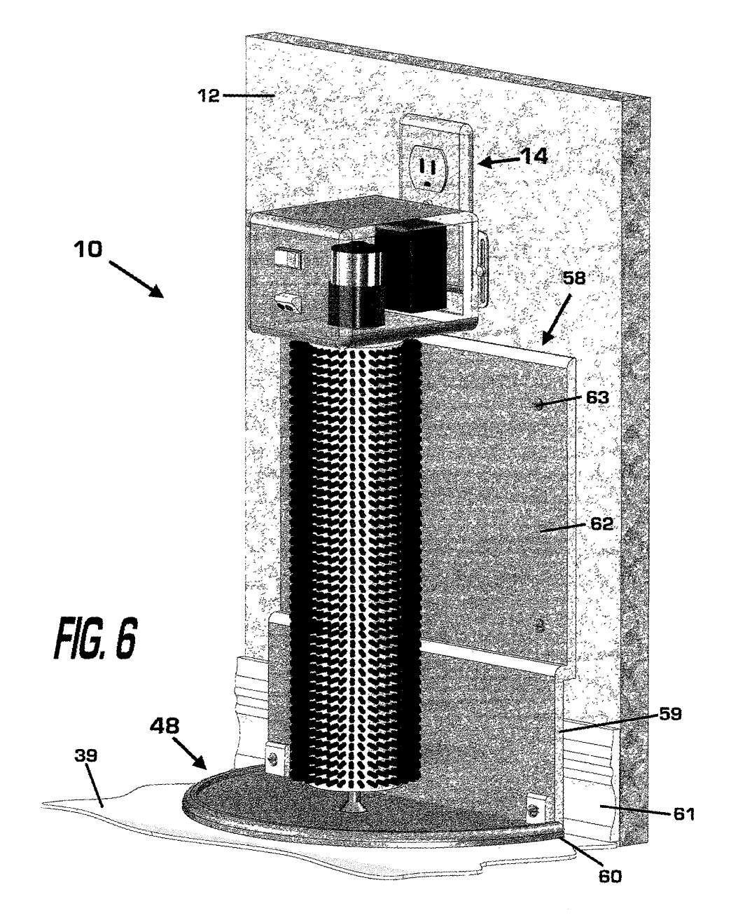

FIG. 6 is a view similar to FIG. 5 with the addition of a generally flat structure 58 to be mounted on the house wall 12 directly behind the animal self-grooming device 10 to provide both wall protection and additional animal clawing or scratching area. The flat structure 58 has raised portion 59 with an edge 60 that contacts the floor 39. The raised portion goes around floor molding 61 and permits the remainder of the flat structure to lie flat against the wall 12. The pad ears 52 are attached to the raised portion 59 of the flat structure. A material 62 suitable for clawing or scratching is similar to that used on the pad 48 and covers that portion of the flat structure 58 that lies flat against the wall 12. The means for attaching the material 62 to the flat structure 58 may also be used to concurrently attach the flat structure to the wall, such as, for example, screws 63.

An alternate embodiment of the animal self-grooming device 66 is shown in FIG. 7. The rubbing means 68 is identical to the rubbing means 24 in FIG. 1, except that it has a recess 67 (shown in dashed line) in its end 69 which is opposite the end 65 that is coupled to the electric motor shaft 22. The housing 70 is similar to the housing 16 of FIG. 1, except it has a pair of side walls 72 which extend the length of the rubbing means 68 and has a hinged cap 74 on the distal ends 71 of the extended side walls. One side wall is partially omitted to show the interior of the housing 70.

Housing 70 comprises a front wall 73 that is attached to the base 75 at an edge thereof which is parallel to and opposite the base edge to which the back wall 77 is attached. A top wall 76 is attached to the front and back walls. A pair of side walls 72 in which each side wall has two legs 78, 79 that are at right angles to each other to form a L-shaped structure. One leg 78 of the side wall is wide and short, while the other leg 79 is thin and long with a distal end 71. The side wall legs 78 are attached to opposing edges of the base 75, front wall 73, back wall 77, and top wall 76, thus forming an enclosure which contains the electric motor 18 and transformer and plug assembly 20. In an identical fashion discussed for the embodiment shown in FIG. 1, the transformer and plug assembly 20 is removable from the housing 66 through an opening 80 in the back wall 77. Opening 80 is shown in dashed line where the view of opening is obstructed by side wall leg 78.

As shown in this view of the animal self-grooming device 66, the transformer and plug assembly has been removed through opening 80 in the back wall 77 and plugged into an electrical wall outlet 14 that is spaced from where the device 66 has been mounted. To show versatility, the animal self-grooming device has been mounted on a wall around the corner from the electrical outlet.

The side wall legs 79 are parallel to each other and are parallel to the rubbing means 68. The side wall legs 79 are spaced from the rubbing means 68, so that the rubbing means resides between the side wall legs 79. An angle shaped member 82 is fixed to the distal ends 71 of the side wall legs 79. A flat panel or cap 74 is attached to an edge of the angle shaped member 82 by a hinge 83. The flat panel or cap 74 has a surface 84 which faces the housing top wall and, thus, the part of the housing 70 that contains the electric motor. A relatively short shaft 85 extends from the cap surface 84 and is perpendicular thereto.

The rubbing means 68 is first coupled to the electric motor shaft 22 that extends through an opening 15a (shown in dashed line) in the top wall 76. Next, the cap 74 is pivoted about the hinge 83 to insert the cap shaft 85 into the recess 67 in rubbing means end 69 to lock the rubbing means in the housing 70. When the rubbing means is installed in the animal self-grooming device 66, the axis 27 of the rubbing means 68, the cap shaft 85 and electric motor shaft 22 are aligned and coaxial. Any suitable means to prevent relative motion between the motor shaft 22 and the recess in the rubbing means end 65 is sufficient.

In the preferred embodiment, a flat (not shown) formed on the motor shaft 22 is used, together with the recess in the rubbing means end 65 being complementary to the motor shaft with the flat thereon. When the electric motor is operated, the rubbing means is rotated about its axis and rotates about the short shaft on the cap 74. The rubbing means may be readily removed by pivoting the cap 74 about the hinge 83 to remove the cap shaft 85 from the recess 67 in the rubbing means end 69 to permit removal and cleaning of the rubbing means or replacement thereof.

A flange 86 extends from each side wall leg 79 and both flanges lie in a common plane. Each flange 86 has an elongated slot 87 therein which is parallel to the side wall legs 79 and each other. The slots 87 are for use by a suitable fastening means, such as, for example, screws 88 to removably attach the animal self-grooming device 66 to a fixed planar surface. One screw 88 is shown on each side of the device 66, but as many screws as desired may inserted through the flange slots 87 to attach the device to the wall 12.

The front wall 73 of housing 70 contains a three-position switch 34a and/or an animal-sensing sensor 35a similar to that of the embodiment shown in FIG. 1. A predetermined length of electrical cord 33, having a length of three to six feet in the preferred embodiment, interconnects the transformer and plug assembly 20 to the electric motor 18 via switch 34a and/or sensor 35a. The unused portion of cord 33 may remain coiled and stored in the housing 70. For convenience and as a safety precaution, a compartment may be formed in the housing by an internal wall (not show for clarity) located between the electric motor 18 and the back wall 77. The unused portion of the cord 33 is stored in the compartment, insuring against a pet owner unintentionally damaging the electric motor. Optionally and as shown in FIG. 7, the transformer and plug assembly 20 is removed from the housing through the opening 80 in back wall 77 and plugged into an electrical wall outlet 14 that is remote from the device 66.

Although the foregoing description illustrates the preferred embodiment, other variations are possible and all such variations as will be apparent to those skilled in the art are intended to be included within the scope of this invention as defined by the following claims.

We claim:

1. An automated animal self-grooming device, comprising:
(a) a housing having a base with an opening therein and a back wall vertically extending from one edge of said base, and
(b) means for rotating a shaft,
(c) said means for rotating said shaft mounted to said base, said means for rotating said shaft causing said shaft to rotate at a preselected rate of revolution, and
(d) said shaft directly coupled to said means for rotating said shaft extending therethrough said opening therein said base, and
(e) rubbing means directly coupled to said shaft extending therethrough said opening therein said base, said rubbing means disposed closely to said base having said opening therein, and
(f) said rubbing means being generally elongated for grooming the coat of an animal automatically.

2. The device of claim 1, wherein said housing is generally rectangular having said base, said back wall, a front wall, two opposing sidewalls, and a top to complete an enclosure.

3. The device of claim 1, wherein said means for rotating said shaft comprises a motor means.

4. The device of claim 3, wherein said motor means is an electric motor.

5. The device of claim 1, wherein said rubbing means comprises a material means suitable for said animal to rub thereon.

6. The device of claim 5, wherein said material means of said rubbing means comprises a cylindrically shaped brush having a rigid body directly coupled to said shaft and a plurality of bristles extending outwardly therefrom said rigid body.

7. The device of claim 1, further including a manual switching means connected to said means for rotating said shaft such that the direction of said shaft may be selectively reversed.

8. The device of claim 1, wherein said means for rotating said shaft further includes an electronic means programmed to automatically change the rotation of said means for rotating said shaft at preselected intervals of time.

9. The device of claim 1, further including a sensor means connected to said means for rotating said shaft causing said means for rotating said shaft to begin operating upon close proximity of said animal.

10. The device of claim 1, wherein said device is attached to a wall having an electrical outlet for powering said means for rotating said shaft.

11. The device of claim 10, further including said device attached to said wall can be selectively mounted in either the upward or downward direction relative to said housing base or floor.

12. The device of claim 1, further including said housing back wall having opposing mounting flanges on each side edge of said back wall of said housing, said flanges having elongated slots to enable the use of screws for firmly attaching said housing to said wall, thereby providing structural support for said device when said animal grooms itself against said rubbing means.

13. The device of claim 6, further including said cylindrically shaped rigid body having opposing ends and an outer surface with the axis being along its length and bristles extending from said outer surface, the first opposing end of said cylindrically shaped rigid body having an axially located recess to receive said shaft end portion extending from said housing base, said housing of said device further comprises a flat panel having a surface which faces the enclosure of said housing, said flat panel surface having a relatively short shaft extending therefrom which is perpendicular thereto, said short shaft on said flat panel may be inserted in and withdrawn from a second axially located recess in the opposite end of said cylindrical shaped rigid body so that each end of said rigid body is supported and held in place when an animal grooms itself against said bristles of said rigid body.
